(19) United States
(12) Patent Application Publication
(10) Pub. No.: US 2004/0210942 A1
(43) Pub. Date: Oct. 21, 2004

(54) Demographic/preference sniffer

(76) Inventor: Thomas Lemmons, Evergreen, CO (US)

Correspondence Address: Morrison & Foerster LLP, Suite 300, 1650 Tysons Boulevard, McLean, VA, 22102, US

(21) Appl. No.: 10/688,067

(22) Filed: Oct. 16, 2003

Related U.S. Application Data
(60) Provisional application No. 60/419,871, filed on Oct. 18, 2002.
(60) Provisional application No. 60/420,110, filed on Oct. 18, 2002.

(51) Int. Cl. H04N 7/16; H04N 7/173; H04N 7/00

(52) U.S. Cl. 725/135; 725/136; 348/461; 715/500.1; 715/513; 725/113; 725/112

(57) ABSTRACT

Disclosed is a system for displaying targeted information based upon preference and/or demographic data. In one embodiment, generalized triggers are sent to a set-top box which contains the preference and/or demographic data. Downloaded addresses of targeted information are selected based upon the trigger and the preference and/or demographic data. Targeted data is then downloaded from a selected site for display to a viewer. In another embodiment, the preference and/or demographic data is stored at an upstream source. In another embodiment, multiple triggers are transmitted to the set-top box which then selects an address of targeted information from the multiple triggers based upon the preference and/or demographic data.

### CROSS REFERENCE TO RELATED APPLICATIONS

This application is based upon and claims the benefit of U.S. Provisional Patent Application Serial No. 60/419,871 by Thomas Lemmons entitled “Demographic/Preference Sniffer” filed Oct. 18, 2002 and U.S. Provisional Patent Application Serial No. 60/420,110 by Thomas Huber et al, entitled “iChoose Video Advertising” filed Oct. 18, 2002, which are hereby specifically incorporated herein by reference for all that they disclose and teach.

### BACKGROUND OF THE INVENTION

a. Field of the Invention

The present invention relates generally to video systems and more specifically to interactive video systems.

b. Description of the Background

Various techniques have been proposed for delivery of Internet based and enhanced content in a television signal. The Advanced Television Enhancement Forum (ATVEF) is a cross-industry group formed to specify a single public standard for delivering interactive and enhanced television experiences. References made herein to the ATVEF specification are made for illustrative purposes only, and such references should not be construed as an endorsement, in any manner, of the ATVEF specification. The ATVEF specification enables interactive television content to be authored using a variety of tools and deployed to a variety of television, set-top and PC based receivers. The ATVEF specification can be found at http://www.atvef.com/library/spec1_{—}1a.html. U.S. patent application Ser. No. 09/818,052 filed Mar. 22, 2001, entitled “System and Method for Local Meta Data Insertion” specifically describes the ATVEF specification and the manner of delivering triggers using Transport type A and Transport type B. This application is specifically incorporated herein by reference for all that it discloses and teaches.

The above referenced patent application entitled “System and Method for Local Meta Data Insertion” discloses methods for stripping triggers from a video signal and replacing those triggers with new triggers. It would be advantageous to use similar techniques to obtain data that is based upon preference and/or demographic information of a viewer or a group of viewers. To date, such techniques have not been employed.

### SUMMARY OF THE INVENTION

The present invention overcomes the disadvantages and limitations of the prior art by providing a system in which triggers can be used to access demographic and/or preference information of viewers (viewer preferred information) to obtain targeted information for display with a video signal. Triggers can comprise any type of notification signal that is embedded or not embedded in a video signal. The targeted information can comprise any information that has specific applicability to either individual viewers or groups of viewers.

The present invention may therefore comprise a method of using a trigger in a video stream to access preferred information for display of targeted information with a video signal comprising: obtaining the preferred information; obtaining a list of addresses of the targeted information; receiving the trigger; selecting an address from the list of addresses of the targeted information based upon the trigger and the preferred information; obtaining the targeted information using the address; combining the targeted information with the video signal for display.

The present invention may further comprise a method of using a trigger from a group of multiple triggers that are associated with a video signal to access preferred information for display of targeted information with a video signal comprising: obtaining the preferred information; obtaining a list of addresses of the targeted information; receiving the multiple triggers; selecting an address from the list of addresses by comparing the multiple triggers with the preferred information; obtaining the targeted information using the address; combining the targeted information with the video signal for display.

The present invention may further comprise a system for displaying targeted information with a video stream comprising: a trigger embedded in the video stream; a decoder that separates the trigger from the video stream; preferred information storage that stores preferred information; address storage that stores IP addresses of the targeted information; a processor that selects an IP address from the IP addresses based upon the trigger and the preferred information and obtains the targeted information using the IP address; a combiner that combines the targeted information with the video signal for display.

The present invention may further comprise a method of using triggers in a video stream to access preferred information for displaying targeted information with a video signal comprising: obtaining the preferred information; receiving the triggers; comparing the triggers to the preferred information; selecting addresses from the triggers that correspond to the preferred information; obtaining the targeted information using the addresses; combining the targeted information with the video signal for display.

Advantages of the present invention include the ability to use demographic and/or preference data (collectively referred to as viewer preferred information) to generate or access targeted information to be displayed with a video signal either on an individual basis or to groups of viewers. This allows, for example, advertisers to target groups or individuals based on demographic or preference information to more effectively advertise products. Further, preferred information can be used by viewers to control the content of information that is displayed on the viewing screen. For example, content rating can be changed by merely selecting preferences for certain content rating. More generically, types of information can be displayed based upon the viewers' preferences. In addition, regional advertisements can be displayed to target certain regions. In fact, any type of content can be displayed based upon preferred information.

### BRIEF DESCRIPTION OF THE DRAWINGS

FIG. 1 is a block diagram of one embodiment of the present invention.

FIG. 2A is a flow diagram of the steps performed by the processor of the embodiment of FIG. 1.

FIG. 2B is another flow diagram of alternative steps that can be performed by the processor of the embodiment of FIG. 1.

FIG. 3 is a block diagram of another embodiment of the present invention.

FIG. 4 is a flow diagram of the steps performed by processor 326 of FIG. 3.

FIG. 5A is a flow diagram of the steps performed by processor 314 of FIG. 3.

FIG. 5B is another flow diagram of alternative steps that can be performed by the processor 314 of FIG. 3.

FIG. 6 is a block diagram of another embodiment of the present invention.

FIG. 7A is a flow diagram of the steps performed by the processor of the embodiment of FIG. 5.

FIG. 7B is another flow diagram of alternative steps that can be performed by the processor of the embodiment of FIG. 5.

### DETAILED DESCRIPTION OF THE INVENTION

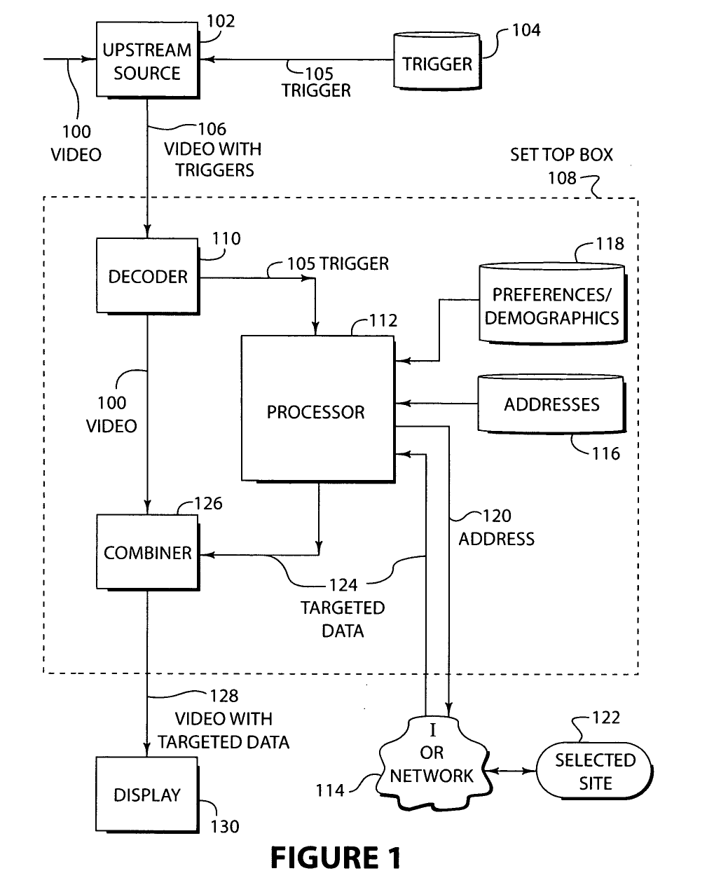

FIG. 1 is a block diagram that schematically illustrates one embodiment of the present invention. A video stream 100 is received by an upstream source 102. The upstream source 102 can comprise any one of a number of different types of upstream sources such as a head-end, content provider, a distribution point, a satellite down link receiver, etc. The upstream source 102 receives trigger information which it embeds in the received video signal 100. The process of embedding the trigger can be accomplished in a number of different ways. As disclosed above, the ATVEF specification can be used to embed the trigger signal as well as any type of process for embedding triggers in the vertical blanking interval or other places of the video stream. For example, the processes and apparatus disclosed in U.S. Pat. Nos. 5,774,664; 5,778,181; 6,018,768; 5,761,606; 6,233,736; 5,907,322 is specifically incorporated herein by reference for all that they disclose and teach.

The triggers can be included in the VBI signal as indicated above, or as a separate packet of data in which a packet ID is used to identify the content of the digital packet such as addresses or other trigger information for all of the embodiments disclosed here. For example, a digital packet may include a series of addresses and other information that defines a time at which an advertising event may commence. Further, the trigger may include information that specifies certain events, such as a frame count that indicates a time when a trigger event may occur. The trigger information can indicate when targeted data should be downloaded from a specific selected address, which may be in advance of the actual display of the targeted data. Alternatively, the trigger may indicate a time at which the targeted data is to be downloaded in real time and inserted in the video signal. Broadcast quality targeted data can be supplied through various network connections known to those skilled in the art. The processors disclosed in the various embodiments of this disclosure may analyze the various networks available for downloading the targeted data and make a decision as to how far in advance the targeted data should be downloaded from a particular targeted site. Various video-on-demand type systems can be used to download the targeted data in nearly real time. The triggers may also constitute other indicators, such as a screen color, a watermark, a checksum, an audio tone, or any other desired triggering method which may indicate an insertion point for the targeted data, or to indicate a time at which to retrieve the targeted data. In addition, various transport mechanisms can be used, such as disclosed in U.S. Patent Application Serial No. 60/420,110, filed Oct. 18, 2002, by Thomas Hubber and Thomas Lemmons, entitled “iChoose Video Advertising,” which is specifically incorporated herein by reference for all that it discloses and teaches.

For all of the embodiments disclosed herein, the trigger information can comprise an address that can be an IP address on an IP network, such as the Internet, or other network, or may be simply an address on any type of network. Also, the address can be an address in a local memory either in the set-top box or in an upstream source, or other local memory. The address specification defines the URL, wherein the URL may identify an address that is resident in set-top box local memory, or is external to the set-top box, such as on a network, or the Internet. The address can also be an address in a remote memory, such as a memory at an upstream source that can be accessed on an asymmetric channel, or an out-of-band channel, such as disclosed in U.S. patent application Ser. No. 09/935,492, filed Aug. 23, 2001, by Steven O. Markel, entitled “System and Method for Web Based Enhanced Interactive TV,” which is specifically incorporated hereby by reference for all that it discloses and teaches.

The address may also include certain category information, key words, and/or ID information, or other selection criteria (hereinafter collectively referred to as “selection criteria”). In other words, an address such as “ford.com” may also include category information such as suv, convertible, truck, sedan, etc., as well as the identification of the source, which is Ford Motor Company, as an example. More specifically, an address such as “ford.com/suv/expedition” identifies a general category “suv” and an even more specific category “expedition,” which is a type of truck produced by Ford Motor Company. Note that these addresses are merely exemplary and the present invention, inventors and assignee are not related to Ford Motor Company and the existence of such sites is not known.

Again, for all of the embodiments disclosed herein, when the trigger is provided as a generalized trigger such as ford.com., the ID information that is stored as a preference or demographic can be compared with the generalized trigger “ford.com.” The processors disclosed in the various embodiments may refer to a table of preferences which provide a table of extensions to the “ford.com” generalized address, such as “suv/explorer” or “convertible/mustang”, etc., that varies depending upon the viewer preferred information that is stored in the extension table. Alternatively, if a URL is received and none of the selection criteria matches any of the preferences or demographics of the viewer, the set-top box may be programmed to use the URL to retrieve the targeted information at that address. The viewer preferred information can, again, be stored either locally in the set-top box, or in an upstream source.

From time to time a system operator may define new categories, key words and/or ID information that may be used by the system. Some of these criteria may be deleted and new ones added over time to reflect general overall tendencies of the society and buying habits, including changes in preference trends. Further, the types of extensions that are provided to the addresses may reflect the various types of programs that are shown. For example, sets of extensions may be used for football games, while other sets of extensions may be used for science programs or educational programs, for example. The extensions may also reflect the viewer's equipment for viewing the programs, such s wide-screen formats, regular formats, high definition formats, etc.

As indicated above, the URL may point to the memory in the set-top box or memory located upstream that contains the targeted information. The targeted information can be downloaded through the VBI and buffered in the set-top box for later display, as more specifically described in U.S. Patent Application Serial No. 60/420,110, filed Oct. 18, 2002, by Thomas Huber and Thomas Lemmons, entitled “iChoose Video Advertising,” which is referenced above.

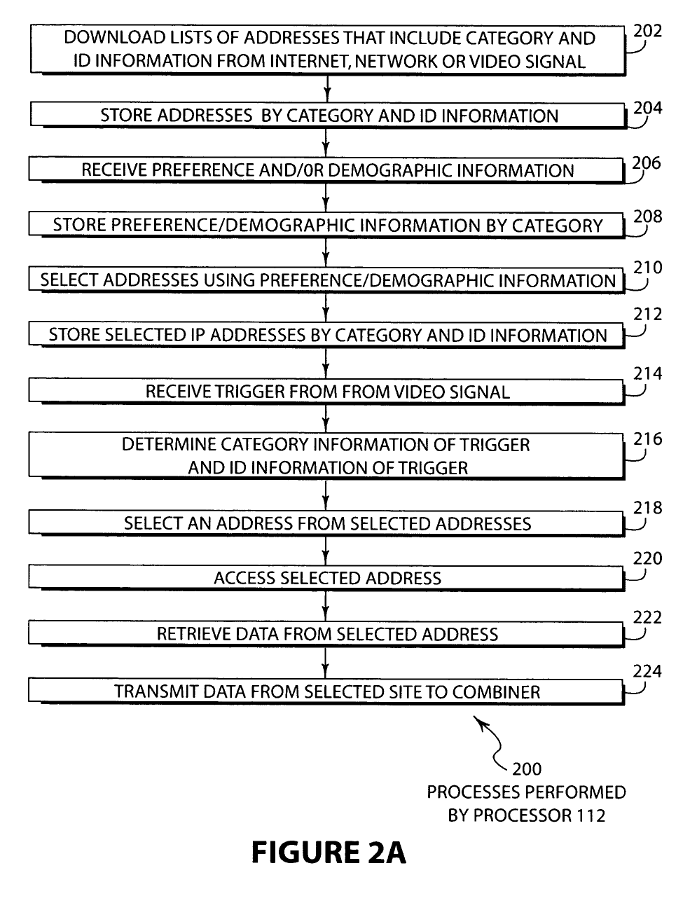

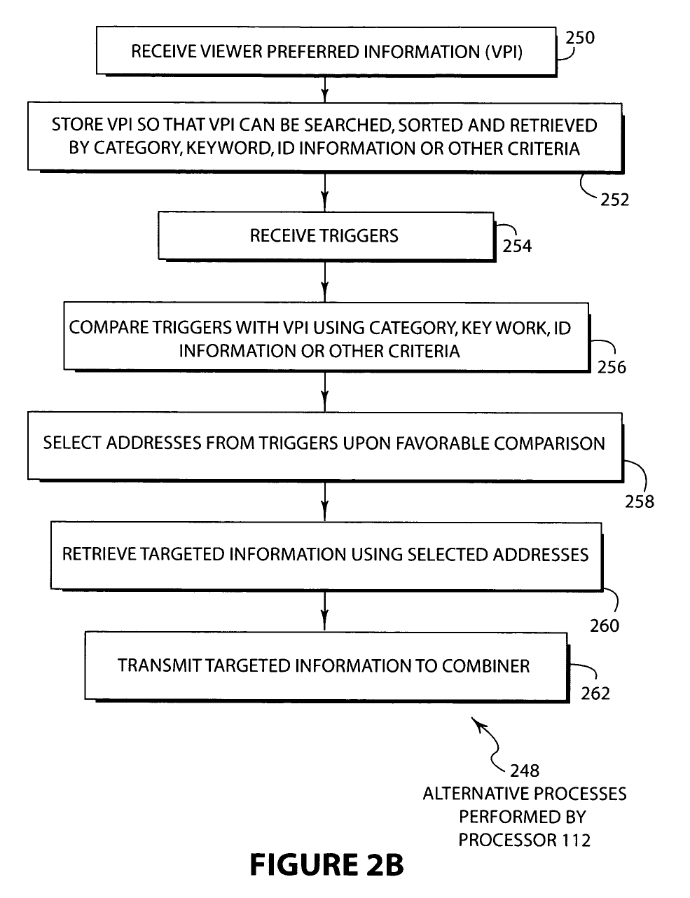

Referring again to FIG. 1, the upstream source 102 inserts the trigger 105 into the video stream 100 and transmits the combined video stream and triggers 106 to a set-top box 108. The set-top box 108 includes a decoder 110 that parses and decodes the trigger 105 from the video signal 100. The trigger 105 is transmitted to a processor 112 in the set-top box 108. The processor 112 performs the functions disclosed in the flow diagram illustrated in FIG. 2.

In brief, the processor 112 may receive a number of addresses that are either downloaded from the combined video and triggers stream 106, or by access to Internet sites located on the Internet 114. These addresses along with category and identification information are stored in the address storage 116. Processor 112 also receives preference and/or demographic information that is either entered by the viewer or some other source. There are various methods of collecting both preference and demographic information. For example, a viewer may enter preference information upon initial setup of the system by completing various forms and answering questions. Further, preference information can be obtained in other ways such as disclosed in U.S. patent application Ser. No. 10/046,618, filed Oct. 26, 2001, by Steven O. Markel, Ian Zenoni and Thomas Lemmons, entitled “Collection of Affinity Data from Television, Video or Similar Transmissions,” U.S. patent application Ser. No. 09/933,928, filed Aug. 21, 2001, by Steven Peliotis, Steven O. Markel, Ian Zenoni and Thomas Lemmons, entitled “iSelect Video,” U.S. patent application Ser. No. 10/080,996, filed Feb. 20, 2002, by Thomas Huber and Ian Zenoni, entitled “Content Based Video Selection” and U.S. Patent Provisional Application No. 60/370,039, filed Apr. 4, 2002, by Ian Zenoni, entitled “Event Driven Interactive TV Notification.” All of these applications are specifically incorporated herein by reference for all that they disclose and teach. Further, preference data can be personalized for specific viewers such as disclosed in U.S. Patent Application No. 09/941,148, filed Aug. 27, 2001, by Thomas Huber, Steven O. Markel, Ian Zenoni and Thomas Lemmons, entitled “Personalized Remote Control.” This application is also specifically incorporated herein by reference for all that it discloses and teaches. As disclosed above, the preference information can be directly, manually entered by the viewer into the set-top box using input devices such as the personalized remote control or any other type of remote control, or can be obtained through usage by detecting patterns of activity of the viewers. Further, preference data can be obtained through Internet sites or connection to various computer systems that may store and collect preference information.

Demographic information may also be obtained through manual entry by a viewer or through collection of data in the various ways disclosed above. This demographic information is also stored in storage device 1118. An example of the use of demographic information is the use of advertising of certain types of vehicles based upon the geographical area of the viewer, such as 4-wheel drive SUVs for mountainous areas, or Convertibles for beach areas. Other types of demographic data, such as income ranges of neighborhoods, regional biases and languages spoken in certain areas, can also be used as preferred information to obtain targeted information.

Both the preference data and demographic data is characterized and placed in certain categories. For example, typical categories may include transportation, furniture, foods, ratings of TV programs, types of TV shows such as action shows, love stories, mysteries, comedies, etc. Any number of categories can be used to classify the viewer preferred data, as described by the viewer or supplier of information.

Referring again to FIG. 1, the processor 112 organizes the addresses 116 in accordance with category and identification information. Addresses that correspond to the category, key word and/or identification information of the viewer preferred information are then stored as preferred addresses, according to category, key word and/or identification information.

The processor 112 receives the trigger 105 and determines the selection criteria from the trigger. The processor 112 selects an address using selection criteria. The address 120 is then used to access a selected site 122 to retrieve targeted data via Internet connection 114. This targeted data can take the form of HTML pages, streaming video, MPEG data, or any desired type of data. References to MPEG encompass any and all digital formats, public or proprietary, that allow transfer of digital information as described in this application. This data 124 is then transmitted back to the processor 112 via the Internet connection 114. Of course, the Internet connection 114 can comprise any type of network and is not necessarily dependent upon the use of the Internet. For example, any type of Intranet or other type of network can be used to retrieve this data from a location where the data is stored. In addition, the network is not restricted to Internet protocol, so the address can be any network address, including IP addresses. The targeted data 124 is then transmitted to the combiner 126. The combiner 126 combines the targeted data with the video stream 100. The video and targeted data stream 128 is then transmitted to a display 130 for display.

The video and targeted data 128 can be combined in any number of different ways. For example, the data can comprise HTML interactive content that appears as standard, interactive TV HTML pages that form an L shape on the screen. Alternatively, the HTML pages can be overlay pages having content placed in specific portions of the video that do not obscure important parts of the video display, as specifically disclosed in U.S. patent application Ser. No. 09/934,108, filed Aug. 21, 2001, entitled “Set-top Preview Program,” by Steven O. Markel and Ian Zenoni, which is specifically incorporated herein in by reference for all that it discloses and teaches. Further, the HTML overlay pages can take the form of “hot spots” in which items are identified with a border or spot that becomes an interactive connection, or as a “hot label” that conveys information, such as an advertisement and also acts as an interactive connection. The hot spots and hot labels may comprise overlay pages such that the overlay page is transparent except for the hot spot or hot label. In addition, the spot or label need not be “hot,” i.e., it can be a non-interactive spot or label. These concepts are more fully disclosed in U.S. patent application Ser. No. 10/041,881, filed Oct. 24, 2001, by Gary Rasmussen, Steven O. Markel, Ian Zenoni, Steven Reynolds and Thomas Huber, entitled “Creating On-Content Enhancements” and U.S. patent application Ser. No. 10/212,289, filed Aug. 2, 2002, by Thomas Lemmons, entitled “Post Production Visual Alterations.” Both of these applications are specifically incorporated herein by reference for all that they disclose and teach. Additionally, the combiner 126 can combine the video signal 100 with data that comprises another video signal to produce a combined video signal such as disclosed in U.S. patent application Ser. No. 10/103,545, filed Mar. 20, 2002, by Steve Reynolds and Thomas Lemmons, entitled “Video Combiner,” which is specifically incorporated herein by reference for that it discloses and teaches. As such, the display 130 may display the video signal with the data in various ways, as described above.

Combined video may employ methods common to television and computers arts including, but not limited to overlay, replacement, logical combination, mathematical combination, chroma keying (aka blue screen), mixing, blending, and ghosting to produce a video output signal from two or more inputs. Such inputs may also vary in format. For example, MPEG, HTML pages, JPEG images, GIF images, and other image formats, either still or motion (including motion JPEG and GIF sequences) are combined with a broadcast video signal as disclosed more fully in the above-referenced application entitled “Video Combiner.”

FIG. 2A is a flow diagram illustrating the processes 200 that are performed by the processor 112 of FIG. 1. Referring again to FIG. 2A, at step 202, the processor downloads lists of Internet addresses (or any type of network address) that include category, key word and/or ID information, or any other selection criteria desired (also referred to herein as “selection criteria.”) These lists of addresses may be downloaded from an Internet link or may be downloaded as addresses that are embedded in the video stream 100. The addresses may be downloaded by the processor 112 in accordance with the stored viewer preferred information. In other words, the viewer preferred information may include a list of key words, categories, and/or ID information that is compared with the various addresses that may be stored at another location, such as the upstream source 102 or an Internet or network site. In such a case, only the addresses that provide a favorable comparison based upon key words, categories, and/or IDs, or, any other parameter selected for comparison, would be downloaded to the address storage device 116. These addresses, which comprise selected addresses, can then be compared to trigger information to retrieve targeted information. Alternatively, addresses may be downloaded by the processor 112 based upon identification information provided by the processor which may include demographic information or preference information that is associated with a particular set-top box. For example, the ID information may identify the boxes being used in a Hispanic neighborhood, so that addresses having targeted information that is directed to Hispanics can be downloaded. Similarly, the processor 112 may contain ID information that accesses a source of addresses that have been specifically sorted to meet the preferences of that particular set-top box. Even further, the processor 112 may simply download addresses that are pre-selected by advertisers, cable companies, satellite companies, system operators, etc. that may receive compensation for providing those addresses.

The addresses that are downloaded by the processor 112 may be addresses that contain specific information. More specific addresses may include information relating to SUVs such as “ford.com/suv/explorer.” Information relating to Convertibles may be stored at a web address such as “ford.com/convertible/mustang.” and so on. The category information that is associated with these addresses may, for example, be “suv” or “convertible.” The ID information may be “ford,” i.e., the domain name, or some other part of the URL. A key word may be “explorer” or “mustang.” Of course, the selection criteria does not have to constitute part of the URL, but may be other information included within the trigger.

Referring again to FIG. 2A, at step 204, the addresses may be stored by the selection criteria in storage device 116, or may be simply stored so that the addresses can be sorted and retrieved using the selection criteria. At step 206, the processor 112 receives viewer preferred information. At step 208, the viewer preferred information is collected and stored with category information, in the manner described above, in storage device 118. At step 210, the processor 112 selects addresses that correspond to the viewer preferred information of the viewer or group of viewers. There are several different ways in which the processor may select the addresses. For example, the processor may perform a key word comparison by comparing the viewer preferred information key words with key words associated with the stored addresses. In addition, comparisons can be made between the category information of the viewer preferred information and the category information of the stored addresses. Further, ID information that is stored as viewer preferred information can be compared to ID information contained in the stored addresses. Further, other types of selection criteria can be used as desired by those skilled in the art.

Referring again to FIG. 2A, the selected addresses are then stored by selection criteria at step 212, or may be simply stored so that the addresses can be sorted and retrieved using various selection criteria. At step 214, the processor 112 receives the trigger 105 that is sent with the video signal 100. The trigger may comprise a generalized trigger, such as ford.com, that simply includes ID information, i.e., “ford.” However, the trigger may include more information, such as “ford.com/suv/explorer,” or “ford.com/convertible/mustang.” In other words, certain category information, such as “suv” or “convertible” may be provided as part of the URL, as well as specific key words, such as “explorer” or “mustang.” As also indicated above, separate category information may be provided that is not part of the URL, as well as separate ID information and/or key words. At step 216, the processor 112 determines the category, key words and/or ID information or other selection criteria that is associated with the trigger 105. Using this category, key word and/or ID information or other selection criteria, the processor 112 selects an address from the selected addresses that are stored in storage device 116 at step 218. At step 220, the processor then accesses the selected site 120 by accessing the Internet 114 using the selected address 120. The selected site 122 then downloads the data 124 which is retrieved by the processor 112 at step 222. The data from the selected site 124 is then transmitted to the combiner 126 at step 224.

FIG. 2B is a flow diagram that illustrates the steps 248 of a series of alternative processes that may be performed by processor 112. At step 250, the processor 112 may receive the viewer preferred information (VPI) that constitutes the preference and/or demographic information. Again, this information may be obtained in various ways such as described above. At step 252 the processor 112 stores the VPI in storage device 118 so that the VPI can be searched, sorted and retrieved by category, key word, ID information or any other criteria known to those skilled in the art. At step 254 the processor 112 receives the triggers. These triggers may be embedded in the video signal, as described above, or may be received through other communication means. At step 256 these triggers are compared with the VPI using the selection criteria. As indicated above, the triggers may contain specific information such as “ford.com/ford/suv/explorer” or “ford.com/convertible/mustang” as examples. In other words, these triggers may contain URL information having key words such as “explorer” or “mustang,” category information such as “suv” or “convertible,” and ID information such as “ford.” The viewer preferred information can then be compared using the selection criteria. In addition, selection criteria of any type including, but not by way of limitation, key words, categories and ID information can be provided as additional information in the trigger that is not part of the URL. At step 258 the processor 112 selects addresses from the triggers based upon a favorable comparison of these various criteria. The viewer preferred information can be classified according to the type of criteria, such as ID information, categories, key words, etc. to insure that a proper comparison and selection is made. At step 260 the processor 112 retrieves the targeted information from the selected addresses. At step 262 the targeted information is then sent to the combiner 126. As shown in this embodiment, it is not necessary to download addresses since the address information is transmitted via the triggers which may or may not be embedded in the video signal.

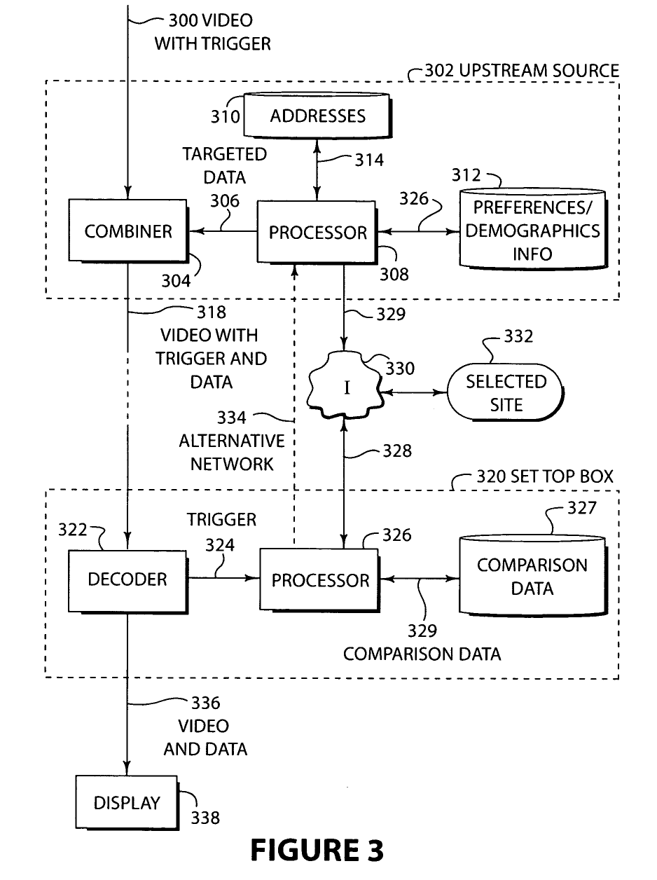

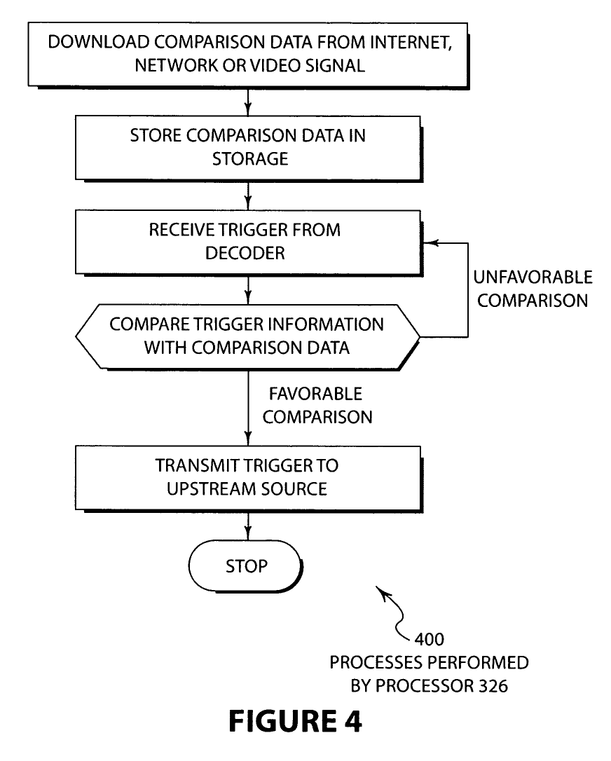

FIG. 3 illustrates another embodiment of the present invention. A video signal 300 that contains a trigger is transmitted to an upstream source 302. Again, the upstream source can be a head-end, a content provider, a distribution center, or any other upstream source. The video signal that contains the trigger 300 is transmitted to an combiner 304. Targeted data 306 from processor 308 may be inserted in the video stream to generate a video signal 318 that contains a trigger and targeted data 306. The video signal 318 containing the trigger and targeted data is transmitted to a set-top box 320. A decoder 322, in the set-top box 320, parses and decodes the trigger 324 from the video signal and transmits the decoded trigger 324 to processor 326. The processes performed by processor 326 are disclosed in FIG. 4.

FIG. 4 is a flow diagram illustrating the processes performed by processor 326. Processor 326 first downloads comparison data 329 from the Internet through connection 328, from any network connection, or from the video signal which has been encoded with comparison data. The comparison data can comprise viewer preferred information or any type of comparison data desired and having any desire type of selection criteria. Processor 326 stores the comparison data 329 in the storage device 327. Processor 326 receives the trigger 324 from the decoder 322. The processor 326 then compares the trigger 324 with the comparison data 329 using selection criteria. If there is an unfavorable comparison, the processor 326 either waits for another trigger or simply uses the address information of the trigger. If there is a favorable comparison, the processor 326 transmits the trigger to the processor 308 in upstream source 302.

Referring again to FIG. 3, the trigger 324 can be transmitted through an Internet connection through the Internet 330 to the upstream source 302 and subsequently to the processor 308. Alternatively, the trigger can be connected through an alternative network connection 334 to the processor 308.

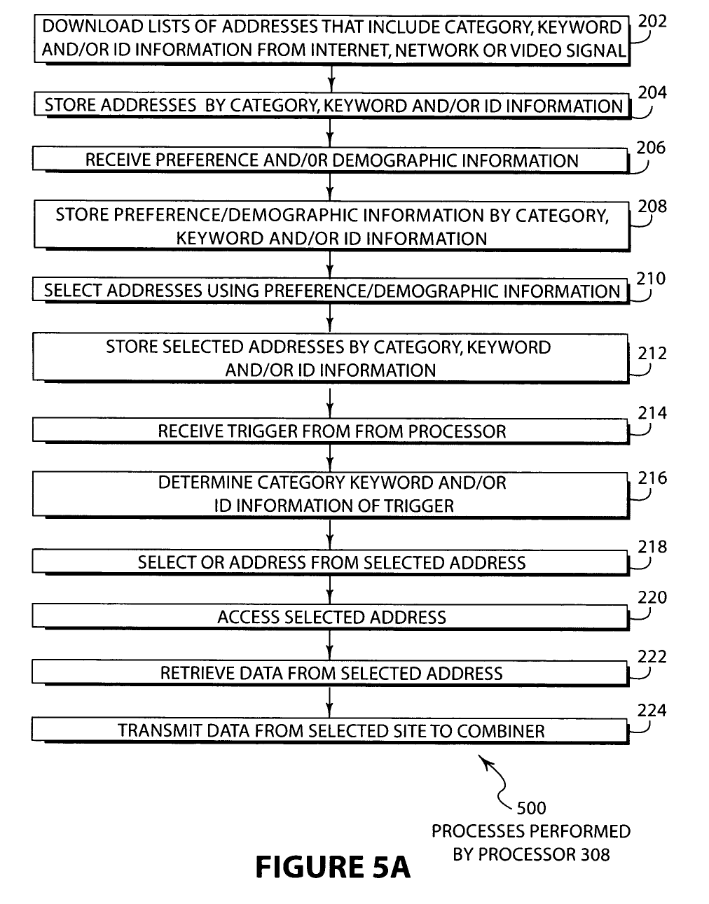

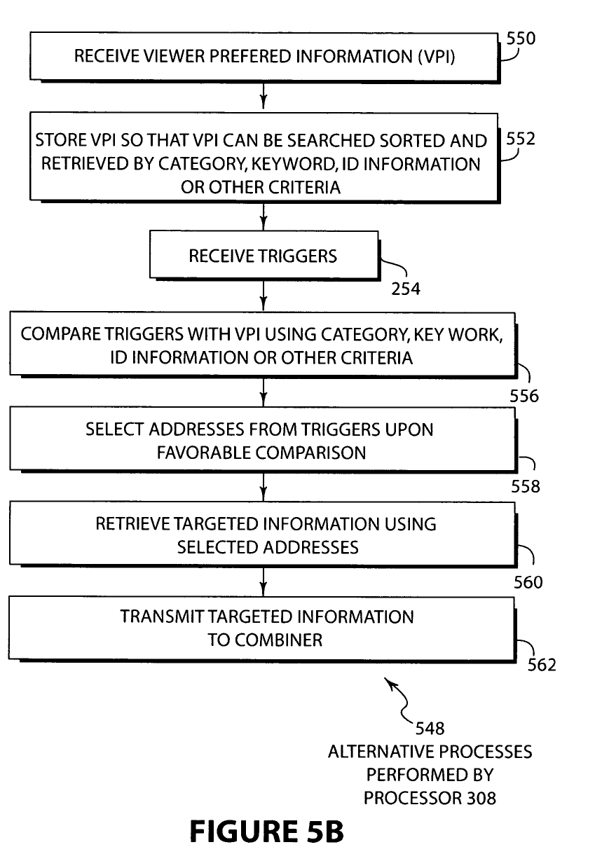

The processor 308 performs the processes 500 illustrated in the flow diagrams shown in FIGS. 5A and 5B. As shown in FIG. 5A, at step 502, the processor 308 downloads lists of addresses that include selection criteria from the Internet, any other type of network, or through the video signal 300. These lists of addresses may be downloaded from an Internet link or may be embedded into the video stream 300. Downloading may be performed in the manner described with respect to FIG. 2A. In addition, the addresses may be similar to those described in the description of FIG. 2A. At step 504, the addresses may be stored by the selection criteria in storage device 310, or may simply be stored so that the addresses can be sorted or retrieved using the selection criteria. At step 506, the processor 308 receives viewer preferred information from storage device 312. At step 508, the viewer preferred information is collected and stored in storage device 312, in the manner described above. At step 510, the processor 308 selects the addresses that correspond to the viewer preferred information of the viewer or groups of viewers.

There are several different ways in which the processor may select the addresses. For example, the processor may perform a key word comparison by comparing the viewer preferred information key words with key words associated with the stored addresses. In addition, comparisons can be made between the category information of the viewer preferred information and the category information of the stored addresses. Further, ID information that is stored as viewer preferred information can be compared to ID information contained in the stored addresses to select certain addresses. Further, other types of selection criteria can be used as desired by one skilled in the art. The selected addresses are then stored by category and ID information at step 512 or may simply be stored so that the addresses can be sorted and/or retrieved using selection criteria. At step 514, the processor 308 receives the trigger 324 from processor 326 via a network connection 334 or an Internet connection 328. The trigger may comprise a generalized trigger such as ford.com that simply includes ID information, i.e., “ford.” However, the trigger may include more information, such as disclosed above, such as “ford.com/suv/explorer” or “ford.com/convertible/mustang”. In other words, certain category information, such as “suv” or “convertible” may be provided as part of the URL, as well as specific key words, such as “explorer” or “mustang.” As also indicated above, separate category information may be provided that is not part of the URL as well as separate ID information and/or key words. At step 516, the processor 308 determines the selection criteria that is associated with the trigger 324. Using selection criteria, the processor 308 selects an address from the selected addresses that are stored in storage device 310 at step 518. At step 520, the processor then accesses the selected site 332 by accessing the Internet 330 through Internet (or other network) connection 329 using the selected address. The selected site 332 then downloads the targeted data 306, which is retrieved by the processor 308 at step 522. The targeted data 306 from the selected site 332 is then transmitted to the combiner 304 at step 524.

Referring again to FIG. 3, the targeted data 306 that is transmitted to the combiner 304 is then combined with the video signal in various alternative ways, such as disclosed above with respect to combiner 126 of FIG. 1. For example, the data 306 may be used as standard interactive data forming an L portion on the screen with the video signal shrunk into the remaining portion of the screen. Alternatively, the data can comprise HTML pages that form “hot spots” or “hot labels, or “non-hot spots” or “non-hot labels.” Further, the data can comprise video data that is combined with the video signal 300 to generate a combined video signal. Again, these various methods of combining the data with the video signal are described above with respect to FIG. 1. The video signal containing the data 318 is then transmitted to the set-top box 320 which further transmits the video and data 336 to the display 338 for viewing by the viewer.

FIG. 5B is a flow diagram that illustrates the steps 548 of a series of alternative processes that may be performed by processor 308. At step 550, the processor 308 may receive the viewer preferred information (VPI) that constitutes the preference and/or demographic information. Again, this information may be obtained in various ways such as described above. At step 552 the processor 308 stores the VPI in storage device 327 so that the VPI can be searched, sorted and retrieved using selection criteria known to those skilled in the art. At step 554 the processor 308 receives the triggers. These triggers may be embedded in the video signal as described above or may be received through other communication means. At step 556 these triggers are compared with the VPI using the selection criteria. As indicated above, the triggers may contain specific information such as “ford.com/ford/suv/explorer” or “ford.com/convertible/mustang” as examples. In other words, these triggers may contain URL information having key words such as “explorer” or “mustang,” category information such as “suv” or “convertible,” and ID information such as “ford.” The viewer preferred information can then be compared using categories, key words and/or ID information, or any other selection criteria. In addition, selection criteria of any type including, but not by way of limitation, key words, categories and ID information can be provided as additional information in the trigger that is not part of the URL. At step 558 the processor 308 selects addresses from the triggers based upon a favorable comparison of these various criteria. The viewer preferred information can be classified according to the selection criteria, such as ID information, categories, key words, etc. to insure that a proper comparison and selection is made. At step 560 the processor 308 retrieves the targeted information from the selected addresses. At step 562 the targeted information is then sent to the combiner 304. As shown in this embodiment, it is not necessary to download addresses since the address information is transmitted via the triggers which may or may not be embedded in the video signal.

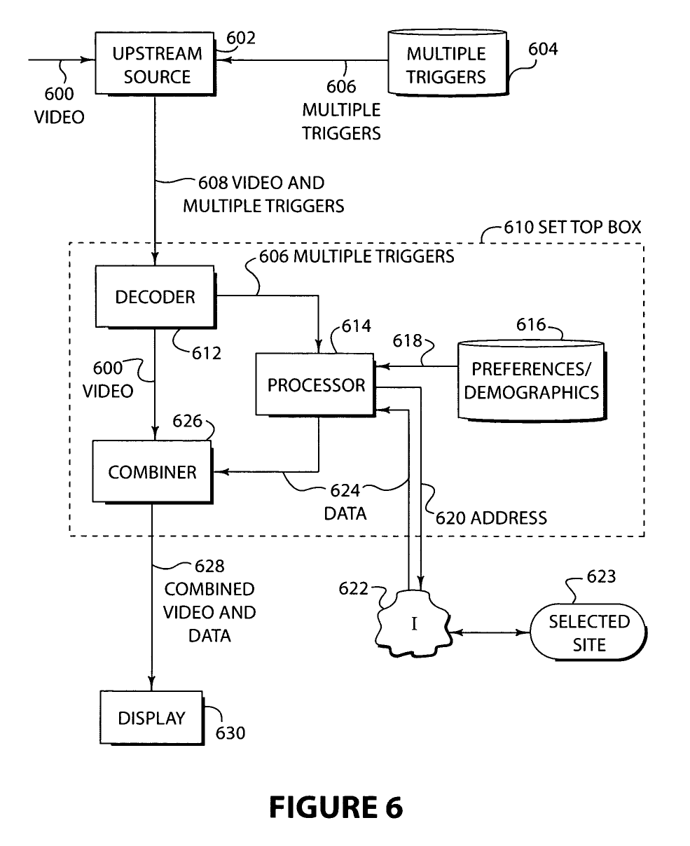

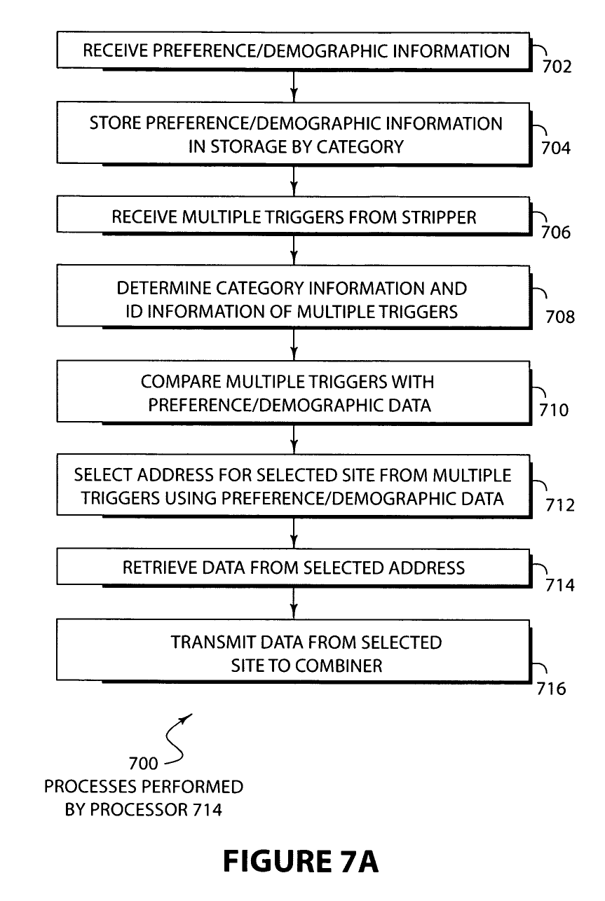

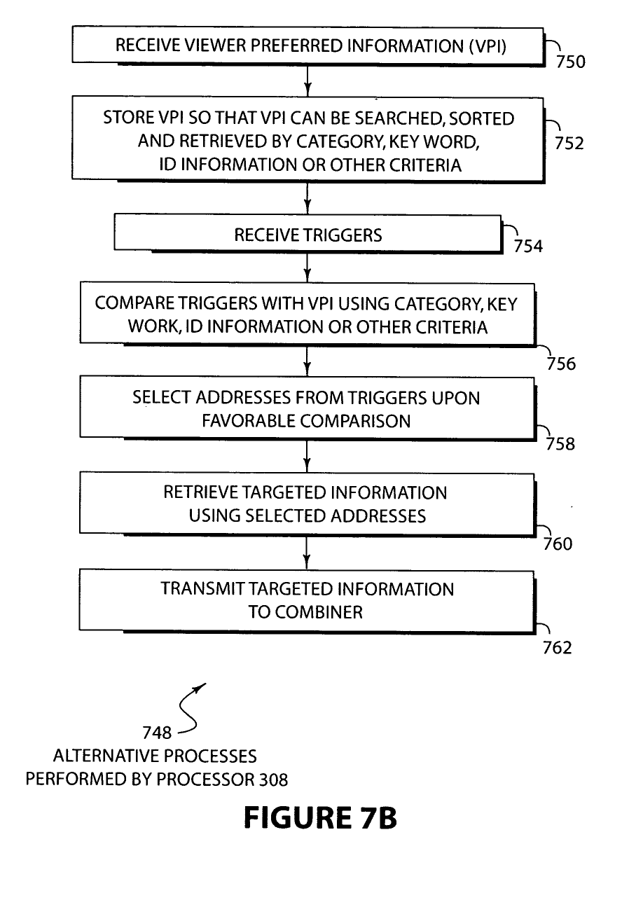

FIG. 6 shows another embodiment of the present invention. Video signal 600 is received by an upstream source 602. Again the upstream source can be a distribution center, a satellite down-link station, a head end or any other upstream source. Storage device 604 provides multiple trigger 606 to the upstream source 602. The multiple triggers are inserted in the video stream by the upstream source to form a video and multiple trigger stream 608. The video and multiple trigger stream 608 is transmitted to a set-top box 610. A decoder 612 parses and decodes the multiple trigger 606 from the video signal 600. The multiple triggers 606 are transmitted to processor 614. The steps performed by the processor 614 are disclosed in the flow diagrams of FIGS. 7A and 7B.

FIG. 7A discloses the processes 700 that are performed by processor 614. At step 702 the processor 614 receives preference and/or demographic information (viewer preferred information) in the manner described above. At step 704 the processor 614 stores the preference and/or demographic information in storage device 616 according to selection criteria, as described above. At step 706 multiple triggers are received by processor 614 from the decoder 612. At step 708 the processor determines the selection criteria of the multiple triggers. At step 710, the processor 614 compares the multiple triggers with the viewer preferred information. At step 712 the processor selects an address for a selected site from the multiple triggers using the viewer preferred information. In other words, if a favorable comparison is made in step 710 between the viewer preferred information and the multiple triggers for a particular criteria, a trigger is selected and address information for that trigger is extracted. If a favorable comparison is not made, the address information for the trigger may be used anyway, as an alternative. At step 714, the address is used to retrieve data from the selected site 623. As shown in FIG. 6, the processor 614 accesses the Internet 622, or other network connection, to access a selected site 623 so that the data 624 can be downloaded to the processor 614. Referring again to FIG. 7, the data is transmitted from the processor 614 to the combiner 626 at step 716.

FIG. 7B is a flow diagram that illustrates the steps 748 of a series of alternative processes that may be performed by processor 614. At step 750, the processor 614 may receive the viewer preferred information (VPI) that constitutes the preference and/or demographic information. Again, this information may be obtained in various ways such as described above. At step 752 the processor 614 stores the VPI in storage device 616 so that the VPI can be searched, sorted and retrieved by category, key word, ID information or any other criteria known to those skilled in the art. At step 754 the processor 614 receives the triggers. These triggers may be embedded in the video signal, as described above, or may be received through other communication means. At step 756 these triggers are compared with the VPI using the selection criteria. As indicated above, the triggers may contain specific information such as “ford.com/ford/suv/explorer” or “ford.com/convertible/mustang” as examples. In other words, these triggers may contain URL information having key words such as “explorer” or “mustang,” category information such as “suv” or “convertible,” and ID information such as “ford.” The viewer preferred information can then be compared using categories, key words or ID information or any other selection criteria. In addition, selection criteria of any type including, but not by way of limitation, key words, categories and ID information can be provided as additional information in the trigger that is not part of the URL. At step 758 the processor 112 selects addresses from the triggers based upon a favorable comparison of these various selection criteria. The viewer preferred information can be classified according to the type of criteria, such as ID information, categories, key words, etc. to insure that a proper comparison and selection is made. At step 760 the processor 614 retrieves the targeted information from the selected addresses. At step 762 the targeted information is then sent to the combiner 626. As shown in this embodiment, it is not necessary to download addresses since the address information is transmitted via the triggers which may or may not be embedded in the video signal.

Referring to FIG. 6, the combiner 626 combines the data 624 with the video stream 600 to create a combined video and data stream 628. The combined video and data stream is transmitted to display 630 for display. As mentioned above, the data can be combined with the video stream in many different ways. For example, the data may comprise HTML data that is displayed as a standard interactive video page, or may comprise overlay pages that use hot spots, hot labels or non-hot spots or non-hot labels. Further, the data may comprise video data that is combined to create a combined video signal, such as described above.

The present invention therefore provides a system in which preference and/or demographic (viewer preferred) information can be used to select targeted data for display to individual viewers or groups of viewers. In this fashion, individual preferences or group demographics can be used to target individuals and/or groups for advertising, or simply displaying targeted information. The targeted information can be either interactive data that takes the form of standard interactive data screens, hot spots, hot labels or non-interactive data, such as non-hot spots or non-hot labels, or can be a combined video signal that displays preferred information.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of using a trigger in a video stream to access preferred information for displaying targeted information with a video signal comprising:
obtaining said preferred information;
obtaining a list of addresses of said targeted information;
receiving said trigger;
selecting an address from said list of addresses of said targeted information based upon said trigger and said preferred information;
obtaining said targeted information using said address;
combining said targeted information with said video signal for display.

2. The method of claim 1 further comprising:
storing said preferred information at a viewer location.

3. The method of claim 2 further comprising:
storing said list of addresses of said targeted information at said viewer location.

4. The method of claim 1 further comprising:
storing said preferred information at an upstream source.

5. The method of claim 4 further comprising:
storing said list of addresses of said targeted information at said upstream source.

6. The method of claim 1 further comprising:
storing said list of addresses by category and identification information;
storing said preferred information by category information;
determining category and identification information of said trigger.

7. The method of claim 6 wherein said step of selecting an address further comprises:
selecting said address of said targeted information using said category information of said preferred information, and said category and identification information of said list of addresses and said trigger.

8. The method of claim 1 wherein said step of combining further comprises:
generating a targeted video signal from said targeted information;
combining said targeted video signal with said video signal to generate a combined video signal.

9. The method of claim 1 wherein said step of combining further comprises:
generating an interactive page from said targeted information.

10. The method of claim 9 wherein said step of combining further comprises:
combining said interactive page with said video signal.

11. A method of using a trigger from a group of multiple triggers that are associated with a video signal to access preferred information for display of targeted information with a video signal comprising:
obtaining said preferred information;
obtaining a list of addresses of said targeted information;
receiving said multiple triggers;
selecting an address from said list of addresses by comparing said multiple triggers with said preferred information;
obtaining said targeted information using said address;
combining said targeted information with said video signal for display.

12. The method of claim 11 further comprising:
storing said list of addresses by category and identification information;
storing said preferred information by category information;
determining category and identification information of said trigger.

13. The method of claim 12 wherein said step of selecting an address further comprises:
selecting said address of said targeted information using said category information of said preferred information, and said category and identification information of said list of addresses and said trigger.

14. The method of claim 11 wherein said step of combining further comprises:
generating a targeted video signal from said targeted information;
combining said targeted video signal with said video signal to generate a combined video signal.

15. The method of claim 11 wherein said step of combining further comprises:
generating an interactive page from said targeted information.

16. The method of claim 111 further comprising:
storing said preferred information.

17. A system for displaying targeted information with a video stream comprising:
a trigger embedded in said video stream;
a decoder that separates said trigger from said video stream;
preferred information storage that stores preferred information;
address storage that stores a plurality of addresses of said targeted information;
a processor that selects at least one address from said plurality of addresses based upon said trigger and said preferred information and obtains said targeted information using said address;
a combiner that combines said targeted information with said video signal for display.

18. The system of claim 17 wherein said combiner comprises:
a video combiner that combines video signals to generate a combined video signal.

19. The system of claim 17 wherein said combiner comprises:
a combiner that combines HTML pages with a video signal.

20. The system of claim 17 wherein said decoder, said preferred information storage, said address storage, said processor and said combiner are all located at a viewer's location.

21. The system of claim 17 wherein said decoder, said preferred information storage, said address storage, said processor and said combiner are all located at an upstream source.

22. A method of using triggers in a video stream to access preferred information for displaying targeted information with a video signal comprising:
obtaining said preferred information;
receiving said triggers;
comparing said triggers to said preferred information;
selecting addresses from said triggers that correspond to said preferred information;
obtaining said targeted information using said addresses;
combining said targeted information with said video signal for display.

23. The method of claim 1 further comprising:
storing said preferred information at a viewer location.

24. The method of claim 2 further comprising:
storing said targeted information at said viewer location.

25. The method of claim 1 further comprising:
storing said preferred information at an upstream source.

26. The method of claim 4 further comprising:
storing said targeted information at said upstream source.

27. The method of claim 1 further comprising:
classifying said preferred information by key words;
classifying said triggers by key words;
selecting addresses from said triggers by comparing key words of said preferred information and said triggers.

28. The method of claim 1 wherein said step of combining further comprises:
generating a targeted video signal from said targeted information;
combining said targeted video signal with said video signal to generate a combined video signal.

29. The method of claim 1 wherein said step of combining further comprises:
generating an interactive page from said targeted information.

30. The method of claim 9 wherein said step of combining further comprises:
combining said interactive page with said video signal.
